(19) United States
(12) Patent Application Publication
(10) Pub. No.: US 2026/0134002 A1
(43) Pub. Date: May 14, 2026

(54) SYSTEMS AND METHODS FOR PROCESSING DATA FOR LARGE LANGUAGE MODELS

(71) Applicant: Infobip Ltd., London (GB)

(72) Inventors: Ivica LOVRIC, Zagreb (HR); Emanuel LACIC, Zagreb (HR)

(73) Assignee: Infobip Ltd., London (GB)

(21) Appl. No.: 18/941,047

(22) Filed: Nov. 8, 2024

(51) Int. Cl. G06F 16/332; G06F 16/35; G06F 16/383

(52) U.S. Cl. CPC G06F 16/3329; G06F 16/35; G06F 16/383

(57) ABSTRACT

A method includes: receiving a query; generating, using a task classifier, a classification associated with the query; generating a score and a context for a subset of large language model providers, among a plurality of large language model providers, that provides a highest correlation with the classification associated with the query; determining, using a contextual bandit, a large language model provider, among the subset of large language model providers, based on a trained model for the contextual bandit; providing the query to the large language model provider; receiving a response from the large language model provider; and updating the trained model for the contextual bandit based on the response.

### TECHNICAL FIELD

Various embodiments of the present disclosure relate generally to systems and methods for processing data for large language models, and, more particularly, to systems and methods for determining a routing path, query, and associated parameters to a large language model provider among a group of large language model providers.

### BACKGROUND

With many large language model providers, each with their own Application Programming Interface (API), user interface, functionalities, fee models, requirements, etc., a user may need to provide a query that is customized to an individual provider, and may not choose the best provider for the query in terms of cost, efficiency, or accuracy, for example.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

In some aspects, the techniques described herein relate to a method including: receiving a query; generating, using a task classifier, a classification associated with the query; generating a score and a context for a subset of large language model providers, among a plurality of large language model providers, that provides a highest correlation with the classification associated with the query; determining, using a contextual bandit, a large language model provider, among the subset of large language model providers, based on a trained model for the contextual bandit; providing the query to the large language model provider; receiving a response from the large language model provider; and updating the trained model for the contextual bandit based on the response.

In some aspects, the techniques described herein relate to a method, further including: providing the response from the large language model provider.

In some aspects, the techniques described herein relate to a method, wherein the trained model for the contextual bandit is trained using one or more of request throughput, cost of using the large language model provider, or quality of the response.

In some aspects, the techniques described herein relate to a method, wherein the trained model for the contextual bandit is trained using a prediction that estimates potential improvements in model performance due to further training or fine-tuning, and balancing exploration and exploitation in the determining by generating an upper confidence bound for each large language model in the subset of large language model providers.

In some aspects, the techniques described herein relate to a method, wherein the trained model for the contextual bandit is trained using a change detection to determine convergence points where a performance of the contextual bandit stabilizes, using sliding windows and thresholding to compare predicted rewards from different time windows, and adjusting the determining based on the predicted rewards.

In some aspects, the techniques described herein relate to a method, wherein the trained model for the contextual bandit is trained using a reward score based on the response from the large language model provider, and using the reward score as feedback in the contextual bandit to refine the determining the large language model provider.

In some aspects, the techniques described herein relate to a method, wherein the reward score is a weighted score of one or more of a periodic scoring of the response from the large language model provider by a review large language model provider, feedback from a user, or a cost of the large language model provider.

In some aspects, the techniques described herein relate to a method, wherein the classification is one or more of a text summary, a translation, an FAQ, or a domain-specific task.

In some aspects, the techniques described herein relate to a method, wherein one or more of the task classifier or the contextual bandit is a machine learning model.

In some aspects, the techniques described herein relate to a method, wherein the context includes one or more of a security level, privacy aspect, efficiency, preference, or cost.

In some aspects, the techniques described herein relate to a method, wherein one or more of the classification, score, or context is provided as a vector.

In some aspects, the techniques described herein relate to a method including: generating, using a task classifier, a classification associated with a query; generating a score and a context for a subset of large language model providers, among a plurality of large language model providers, that provides a highest correlation with the classification associated with the query; determining, using a contextual bandit, a large language model provider, among the subset of large language model providers, based on a trained model for the contextual bandit; and providing the large language model provider.

In some aspects, the techniques described herein relate to a method, further including: providing the query to the large language model provider; receiving a response from the large language model provider; and updating the trained model for the contextual bandit based on the response.

In some aspects, the techniques described herein relate to a method, wherein the updating the trained model for the contextual bandit includes one or more of: providing the response to a review large language model provider and receiving a review score from the review large language model provider, generating a feedback score based on feedback from a user for the response, or generating a cost score based on a cost of the response from the large language model provider.

In some aspects, the techniques described herein relate to a method, wherein the contextual bandit includes a trained machine learning model.

In some aspects, the techniques described herein relate to a method, wherein the updating the trained model for the contextual bandit includes training the machine learning model of the contextual bandit.

In some aspects, the techniques described herein relate to a method, further including: aggregating the classification, the score, the context, and the query as a vector; and providing the vector to the contextual bandit to determine the large language model provider.

In some aspects, the techniques described herein relate to a system including one or more processors configured to execute a method including: receiving a query; generating, using a task classifier, a classification associated with the query; generating a score and a context for a subset of large language model providers, among a plurality of large language model providers, that provides a highest correlation with the classification associated with the query; determining, using a contextual bandit, a large language model provider, among the subset of large language model providers, based on a trained model for the contextual bandit; providing the query to the large language model provider; receiving a response from the large language model provider; and updating the trained model for the contextual bandit based on the response.

In some aspects, the techniques described herein relate to a system, wherein the task classifier is a first machine learning model and the contextual bandit is a second machine learning model.

In some aspects, the techniques described herein relate to a system, wherein the updating the trained model for the contextual bandit includes generating a reward score based on the response from the large language model provider, and updating the trained model for the contextual bandit based on the reward score.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system infrastructure for a large language model provider routing system, according to one or more embodiments.

FIG. 2 depicts a flowchart of a method of routing a query to a large language model provider, according to one or more embodiments.

FIG. 3 depicts a flowchart of a method of generating dynamic client exposed API capability based on integrated model capabilities of a large language model provider routing system, according to one or more embodiments.

FIG. 4 depicts a flowchart of a method of routing a query to a large language model provider, according to one or more embodiments.

FIG. 5 depicts a flowchart of a method of analyzing content of a request to a large language model provider routing system, according to one or more embodiments.

FIG. 6 depicts a flowchart of a method of a cache lookup in a large language model provider routing system, according to one or more embodiments.

FIG. 7 depicts a flowchart of a method of compressing a request to a large language model provider routing system, according to one or more embodiments.

FIG. 8 depicts a flowchart of a method of routing a query to a large language model provider, according to one or more embodiments.

FIG. 9 depicts a flowchart of a method for checking health of a large language model provider routing system, according to one or more embodiments.

FIG. 10 depicts a flowchart of another method for checking health of a large language model provider routing system, according to one or more embodiments.

FIG. 11 depicts an exemplary system infrastructure for a large language model provider routing system, according to one or more embodiments.

FIG. 12 depicts a flowchart of a method for determining a large language model provider routing system, according to one or more embodiments.

FIG. 13 depicts a flowchart of a method for providing a large language model provider routing system, according to one or more embodiments.

FIG. 14 is a simplified functional block diagram of a computer system that may be configured as a device for executing the techniques disclosed herein, according to one or more embodiments.

FIG. 15 depicts a flow diagram for training a machine learning model, according to one or more embodiments.

### DETAILED DESCRIPTION OF EMBODIMENTS

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value. In this disclosure, unless stated otherwise, any numeric value may include a possible variation of ±10% in the stated value.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Various embodiments of the present disclosure relate generally to systems and methods for processing data for large language models, and, more particularly, to systems and methods for determining a routing path, query, and associated parameters to a large language model provider among a group of large language model providers. Embodiments disclosed herein are directed to an improvement of LLM technology. In accordance with these embodiments, a client may be able to utilize one or more of a plurality of LLM models most applicable to a client query. The one or more of the plurality of LLM models may be identified in a cost and resource efficient manner by matching queries to applicable LLM models. A plurality of available LLM models may be filtered such that only applicable LLM models are used to respond to a given query. Such filtering and LLM model determination makes use of a multiple LLM model system faster than conventional techniques. For example, embodiments disclosed herein allow for faster query response using applicable LLM models rather than a trial and error system.

An entity may benefit from receiving a large language model output for a given request (e.g., via a query). The entity may further benefit from receiving such an output from one or more of a plurality of large language model providers (e.g., based on given attributes or training of the one or more such providers, based on the request, based on the entity, etc.). With many large language model providers, one or more of which with their own Application Programming Interface (API), user interface, functionalities, fee models, requirements, etc., a user may need to provide a query that is customized to an individual provider, and may not choose the best provider for the query in terms of cost, efficiency, and/or availability, for example. One or more embodiments may provide a system to cooperate with many large language model providers, may standardize a query, or input request, and may provide a single access point for users with a standardized API endpoint.

One or more embodiments may receive a query, determine a large language model provider, among a group of large language model providers, that best matches a capability associated with the query, generate a modified query for the large language model provider, and provide the modified query to the large language model provider. One or more embodiments may provide a system with specific optimizations to, for example, reduce tokens in the query, to cache embedding, and/or to provide the modified query to a fallback large language model provider if a first provider does not respond within a threshold time. One or more embodiments may provide a system including an agnostic large language model (LLM) router that connects to multiple LLM providers, and requests a standardized LLM action with one or more preferences or task types.

An LLM model as discussed herein may be any applicable LLM such as but not limited to a Language Representation Model, a Natural Language Processor, a Zero-shot Model, a Multimodal Model, a Fine-tuned Model, a Domain-specific Model, a Large Language Model (e.g., Pathways Language Model (PaLM), XLNet, Bidirectional Encoder Representations from Transformers (BERT), Generative pre-trained transformers (GPT), Large Language Model Meta AI (LLAMA), and/or the like. One or more embodiments may provide a system including advanced functionalities such as fallbacks, least cost routing, prompt compressions, and/or prompt caching routing by functionality and/or metric scores representing a competence level of a model.

One or more embodiments may provide a system including smart LLM routing based on one or more of least cost, fallback, best quality, or best accuracy. One or more embodiments may provide a system including smart LLM routing based on a feature requested, including one or more of text generation, language translation, text completion, summarizations, question answering, chatbot functionality, or image generation. One or more embodiments may provide a system including a single integration that simplifies LLM usage by standardizing service input from one or more of queries, usage tracking per use cases or segments, or metrics. One or more embodiments may provide a system that provides cost savings, by implementing one or more of prompt caching and prompt compression.

One or more embodiments may provide a system that provides observability using various metrics, such as cost tracking and savings tracking, for example. One or more embodiments may provide a system that increases an accuracy of a response to a query. One or more embodiments may provide a system that receives feedback from a user regarding the quality of a response to a query. For example, feedback may be received by a client in an additional API request for score submission referring to a prior response correlated by an identifier. Feedback may be submitted for score adjustment without providing a “correct” response and/or for score adjustment by providing a “correct” response.

Feedback may be provided via score alternation. Score alternation may have a tendency to decrease a feedback score. Score alternation may receive only an identifier and score (e.g. in a range from 1-10). For example, score alternation may use a Gompertz function to curb potential extreme score lowering with slowly falling properties. Score alternation may be applied periodically after N number of samples are collected. Score alternation may not change an LLM, but may alter an accuracy score for a reported action. Feedback may be provided via fine tuning. Fine tuning may have a tendency to increase a feedback score. Fine tuning may receive an identifier and a correct answer. Fine tuning may be process intensive relative to score alternation. Fine tuning may be applied periodically after N number of samples are collected. Fine tuning may update an LLM based on the provided correct answers.

One or more embodiments may provide a system that moves external LLM integrations and authentications from multiple services to a single router, while simplifying and unifying a client-side API endpoint. One or more embodiments may provide a system where an end user or service can easily choose an LLM task, by using a flag, for example, without requiring knowledge of particular systems and technologies for LLM providers. One or more embodiments may provide a system where an end user or service can easily track and monitor usage, savings, and other metrics by accessing a single API endpoint. One or more embodiments may provide a system that offers savings to end users by using smart approaches, such as prompt caching, compression, and/or choosing a least cost provider, for example, when querying an LLM provider. One or more embodiments may be used in voice or real-time communication infrastructure.

One or more embodiments may provide a system for dynamically routing input queries to a most appropriate Large Language Model (LLM). The LLM may be a commercially available LLM or an internally deployed LLM, and the LLM may be fine-tuned for domain-specific tasks. Upon receiving a query, the system may use a trained model to score the input query, by determining associated capabilities and context. The system may leverage a routing system equipped with contextual bandit algorithms to determine an optimal LLM provider from a pool of available models. The contextual bandit may determine different options, and may learn from the generated results. This may be done using a provided context (e.g., input query and current cost consumptions) to determine which options work best in which situations. The system may provide a balance between the exploration of new options, in order to gather more information, and to exploit known options that have worked well in previous situations. Over time, the algorithm may better determine options that yield the highest rewards based on the contextual information available.

The system may dynamically select the optimal LLM by generating a reward score based on the output quality of the chosen LLM. This score may be used as feedback in the system to refine the selection strategy. The system may balance several optimization criteria, such as throughput, cost, and response quality, for example, by employing and adjusting strategies based on ongoing performance data.

The system may include a prediction phase that estimates potential improvements in model performance due to further training or fine-tuning. The system may generate an upper confidence bound for each LLM, which combines an empirical mean reward (e.g., a value that approximates a mean reward for a given number of iterations) with an uncertainty term that decreases as more data is collected, which may effectively balance exploration and exploitation. The system may include a change detection phase that monitors a performance trend of each LLM. Using sliding windows and a thresholding technique, the system may compare the predicted rewards from different time windows to detect significant changes, and may determine points where the model performance stabilizes. This may allow the system to adapt the selection strategy and maintain increased performance. The system may provide efficient and economic model selection, and may cater to various tasks such as summarization, FAQ, translation, and domain-specific inquiries, for example.

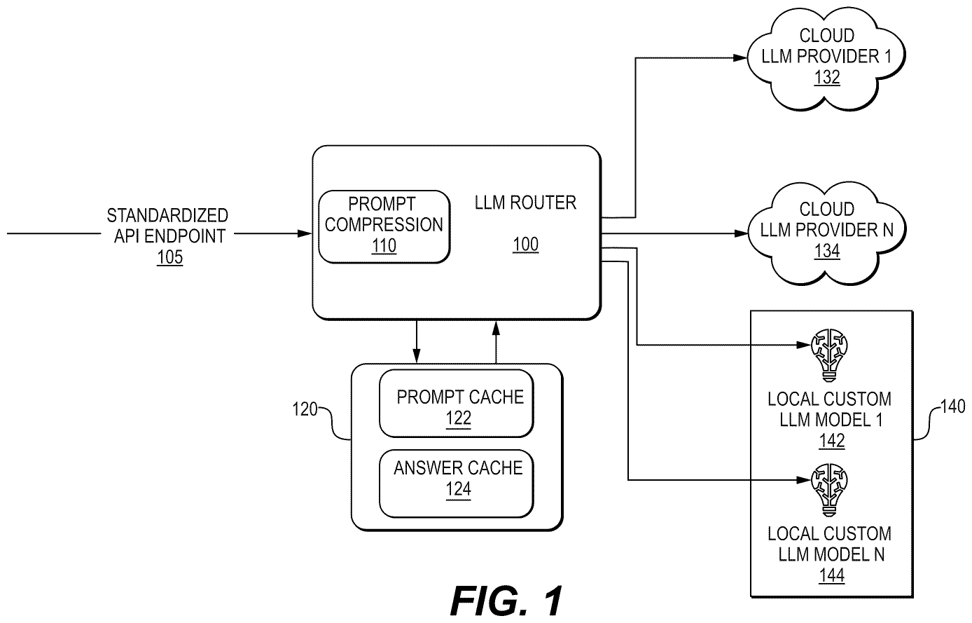

FIG. 1 depicts an exemplary system infrastructure for a large language model provider routing system, according to one or more embodiments. As shown in FIG. 1, a router, or routing system, 100 to a large language model provider may include or communicate with a standardized API endpoint 105 to receive a query. Routing system 100 may include a prompt, or query, compressor 110. Routing system 100 may include or communicate with cache storage 120, first LLM provider 132 (e.g., a cloud LLM provider), second LLM provider 134 (e.g., a cloud LLM provider), and local LLM model 140. Cache storage 120 may include or communicate with prompt, or query, cache 122 and answer cache 124. Local LLM model 140 may include first local LLM model 142 and second local LLM model 144. Although first LLM provider 132, second LLM provider 134, and local LLM model 140 are generally described herein, it will be understood that any applicable number of LLM providers may be applied to embodiments disclosed herein.

Routing system 100 may receive a query via a standardized API endpoint 105, and may compress the received query using query compressor 110 to reduce a number of tokens, such as a number of words, characters, bits, redundancies, etc., for example, in or associated with the query. Compressing the query may include removing one or more tokens from the query. Compressing the query may reduce one or more of storage costs, processing time, or LLM provider costs, for example. Routing system 100 may process one or more of the received query or the compressed query using cache storage 120. Routing system 100 may use cache storage 120 to determine whether the query is similar to (e.g. above a similarity threshold) one or more of a previously received query or a previously compressed query stored in query cache 122, and if so, may retrieve and re-use a previously provided response stored in answer cache 124.

If the received query is not similar to (e.g. below a similarity threshold) a previously received query or a previously compressed query stored in query cache 122, routing system 100 may determine whether to provide (e.g. send) the received query to one or more of first LLM provider 132, second LLM provider 134, first local LLM model 142, or second local LLM model 144. For example, routing system 100 may determine routing based on one or more of least cost, fallback, best quality, or best accuracy. Routing system 100 may determine routing based on a feature requested, including one or more of text generation, language translation, text completion, summarizations, question answering, chatbot functionality, or image generation (e.g., requested as part of or as a supplement to the query).

One or more embodiments may include determining (e.g., extracting) one or more capabilities associated with a query. As used herein, capabilities may include, but are not limited to, a query format (e.g., a question, a pattern request, a trend request, a task request, a summary request, etc.), a sentiment associated with the query, a content type (e.g., image, chart, text, video, audio, etc.), an analysis type (e.g., historical analysis, data analysis, etc.), a computation, and/or the like.

A capability associated with a query may be determined using a capability machine learning model. The capability machine learning model may receive the query as an input and may output one or more capabilities. The capability machine learning model may be trained in accordance with techniques disclosed herein with respect to one or more other machine learning models. For example, the capabilities machine learning model may be trained based on historical or simulated queries and/or historical or simulated capabilities associated with such historical or simulated queries. One or more weights, layers, nodes, synapsis, biases, or weights may be adjusted based on such historical or simulated data that may, for example, be tagged.

Alternatively, or in addition, a query may be segmented using a segmentation model. The query may be segmented based on query structure, terms or content associated with the query, and/or the like. The segmentation model may assign weights to different segments of the query based on predetermined or dynamically determined rules applied to the query. The segmentation model may output a segmentation score for each or a subset of the segments. The segmentation scores for each or all of the segments may be correlated with capabilities such that one or more capabilities with a segmentation score above a given threshold may be associated with the query. As further discussed herein, query capabilities may be matched with one or more LLM model capabilities to select optimal LLM models for the query.

One or more embodiments may include providing the received query as an input to an determination machine learning model trained based on historical or simulated queries, historical or simulated LLM selections, historical or simulated LLM outputs, and/or the like (“determination model training data”). The determination model training data may be applied to a machine learning algorithm to train the determination machine learning mode. The training may include initializing, updating, and or adjusting one or more weights, layers, biases, nodes, synapses or the like of the determination machine learning model based on the determination model training data and/or training algorithm. The determination machine learning model may be configured to receive, as inputs, the received and/or compressed query and may further be configured to receive inputs such as, but not limited to, client information, cached queries, current event information, and or the like. The determination machine learning model may apply one or more of the inputs to output one or more LLM models. For example, the determination machine learning model may apply the inputs to one or more layers, weights, biases, synapses, or nodes to output one or more LLM models.

Alternatively, or in addition, the determination machine learning model may output a determination score associated with all or a subset of available LLM models. The determination score for a given LLM model may be an overall score for the given LLM model. Alternatively, or in addition, the determination machine learning model may output a score for each of one or more categories associated with the query and/or LLM model. For example, the determination machine learning model may output a storage cost score, a processing time score, and/or an LLM provider cost score for each or a subset of the available LLM models. According to this embodiment, routing system 100 may select one or more LLM models based on an overall score or category based scores for each or a subset of the available LLM models. For example, routing system 100 may select one or more LLM models based on such scores and further based on a given client's settings, preferences, prior priorities, or on a given query's attributes or ranking.

For example, an LLM entities model may include:

```
{
  “models”: [
  {
    “name”: “GPT-3”,
    “description”: “Generative Pre-trained Transformer 3”,
    “Cost metric”: “token”,
    “Cost”: “0.03”,
    “Average user score”: “X”,
    “capabilities”: [
    “Textgen”,
    “Text generation”,
    “Language translation”,
    “Text completion”,
    “Text summarization”,
    “Question answering”,
    “Chatbot functionality”
    ],
  “metrics”: [
    {
      “ROUGE”: “XXX”,
      “BLEU”: “XXX”,
      “METEOR”: “XXX”,
      “COMET”: “XXX”,
      “BERT”: “XXX”,
    }
    ],
  “status”: [
    {
      “Reachable”: “true”,
      “Enabled”: “false”
    }
    ],
    “api_link”: “https://openai.com/gpt-3”
  },
  {
    “name”: “GPT-4”,
    “description”: “Generative Pre-trained Transformer 4”,
    “Cost metric”: “token”,
    “Cost”: “0.06”,
    “Average user score”: “X”,
    “capabilities”: [
    “Textgen”,
    “Text generation”,
    “Language translation”,
    “Text completion”,
    “Text summarization”,
    “Question answering”,
    “Chatbot functionality”
    ],
  “metrics”: [
    {
      “ROUGE”: “XXX”,
      “BLEU”: “XXX”,
      “METEOR”: “XXX”,
      “COMET”: “XXX”,
      “BERT”: “XXX”,
    }
    ],
  “status”: [
    {
      “Reachable”: “true”,
      “Enabled”: “true”
    }
    ],
    “api_link”: “https://openai.com/gpt-4”
  },
  {
    “name”: “BERT”,
    “description”: “Bidirectional Encoder Representations from
    Transformers”,
    “Cost metric”: “token”,
    “Cost”: “0.03”,
    “Average user score”: “X”,
    “capabilities”: [
    “Natural language understanding”,
    “Text classification”,
    “Named entity recognition”,
    “Text summarization”,
    “Question answering”
    ],
  “metrics”: [
    {
      “ROUGE”: “XXX”,
      “BLEU”: “XXX”,
      “METEOR”: “XXX”,
      “COMET”: “XXX”,
      “BERT”: “XXX”,
    }
    ],
  “status”: [
    {
      “Reachable”: “true”
      “Enabled”: “false”
    }
    ],
    “api_link”: “https://github.com/google-research/bert”
  },
  {
    “name”: “ELMo”,
    “description”: “Embeddings from Language Models”,
    “Cost metric”: “token”,
    “Cost”: “0.02”,
    “Average user score”: “X”,
    “capabilities”: [
    “Word embeddings”,
    “Contextualized word representations”
    ],
  “metrics”: [
    {
      “ROUGE”: “XXX”,
      “BLEU”: “XXX”,
      “METEOR”: “XXX”,
      “COMET”: “XXX”,
      “BERT”: “XXX”,
    }
    ],
  “status”: [
    {
      “Reachable”: “true”,
      “Enabled”: “false”
    }
    ],
    “api_link”: “https://allennlp.org/elmo”
  },
  {
    “name”: “FastText”,
    “description”: “Library for efficient learning of word representations”,
    “Cost metric”: “token”,
    “Cost”: “0.02”,
    “Average user score”: “X”,
    “capabilities”: [
    “Word embeddings”,
    “Text classification”,
    “Text categorization”
    ],
  “metrics”: [
    {
      “ROUGE”: “XXX”,
      “BLEU”: “XXX”,
      “METEOR”: “XXX”,
      “COMET”: “XXX”,
      “BERT”: “XXX”,
    }
    ],
  “status”: [
    {
      “Reachable”: “false”,
      “Enabled”: “false”
    }
    ],
    “api_link”: “https://fasttext.cc/”
  },
  {
    “name”: “XLNet”,
    “description”: “Generalized Autoregressive Pretraining for Language
Understanding”,
    “Cost metric”: “token”,
    “Cost”: “0.02”,
    “Average user score”: “X”,
    “capabilities”: [
    “Textgen”,
    “Text generation”,
    “Natural language understanding”,
    “Text classification”,
    “Text completion”,
    “Question answering”
    ],
  “metrics”: [
    {
      “ROUGE”: “XXX”,
      “BLEU”: “XXX”,
      “METEOR”: “XXX”,
      “COMET”: “XXX”,
      “BERT”: “XXX”,
    }
    ],
  “status”: [
    {
      “Reachable”: “true”,
      “Enabled”: “true”
    }
    ],
    “api_link”: “https://github.com/zihangdai/xlnet”
  },
  {
    “name”: “GODEL”,
    “description”: “Large-scale pretrained models for goal-directed dialog -
Chatbot / Opensource”,
    “Cost metric”: “hour”,
    “Cost”: “0.1”,
    “Average user score”: “X”,
    “capabilities”: [
    “GPU”,
    “Local deployment”,
    “Chatbot functionality”,
    “Question answering”
    ],
  “metrics”: [
    {
      “ROUGE”: “XXX”,
      “BLEU”: “XXX”,
      “METEOR”: “XXX”,
      “COMET”: “XXX”.
      “BERT”: “XXX”,
    }
    ],
  “status”: [
    {
      “Reachable”: “true”,
      “Enabled”: “false”
    }
    ],
    “api_link”: “https://github.com/microsoft/GODEL”
  }
  ]
}
```

In response to the provided query, routing system 100 may receive an answer, or response, from one or more of first LLM provider 132, second LLM provider 134, first local LLM model 142, or second local LLM model 144.

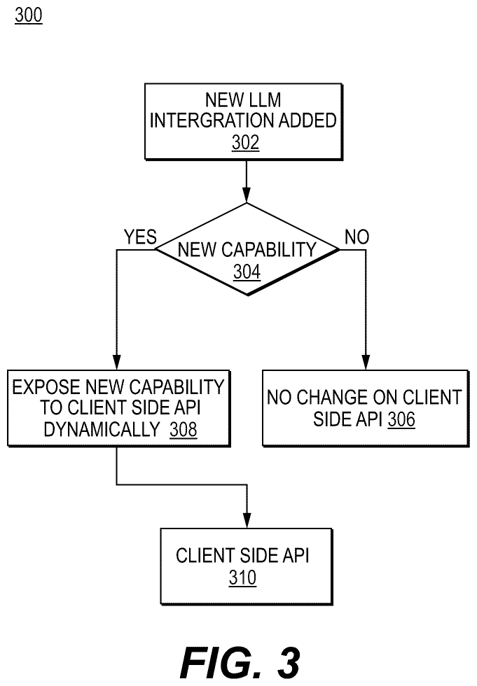

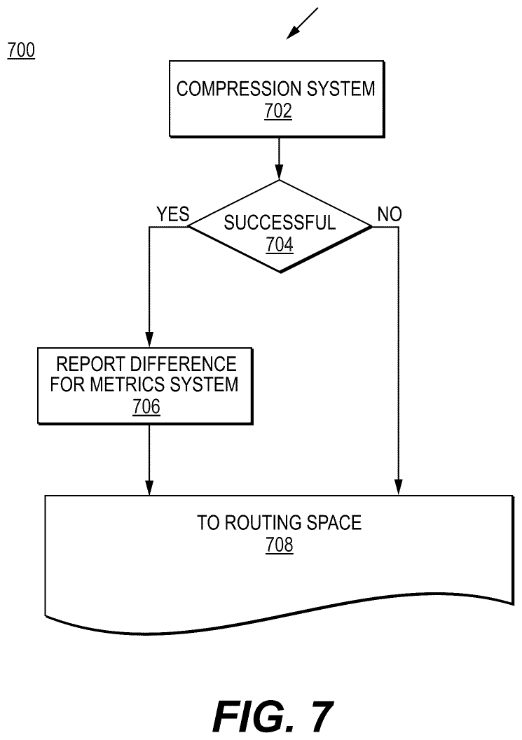

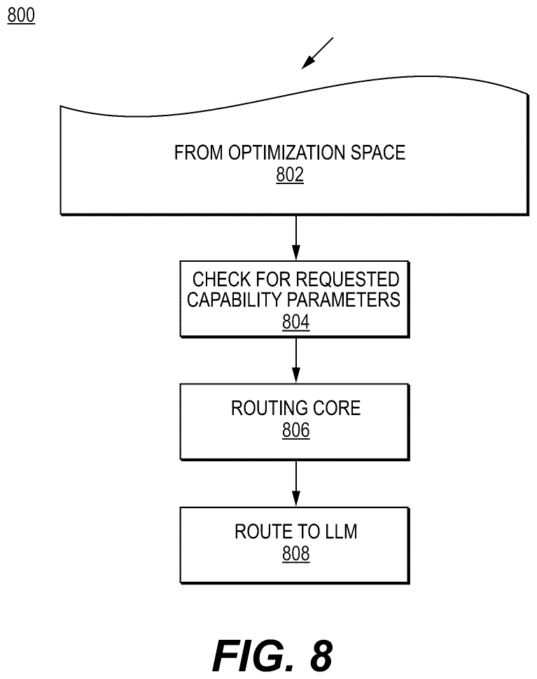

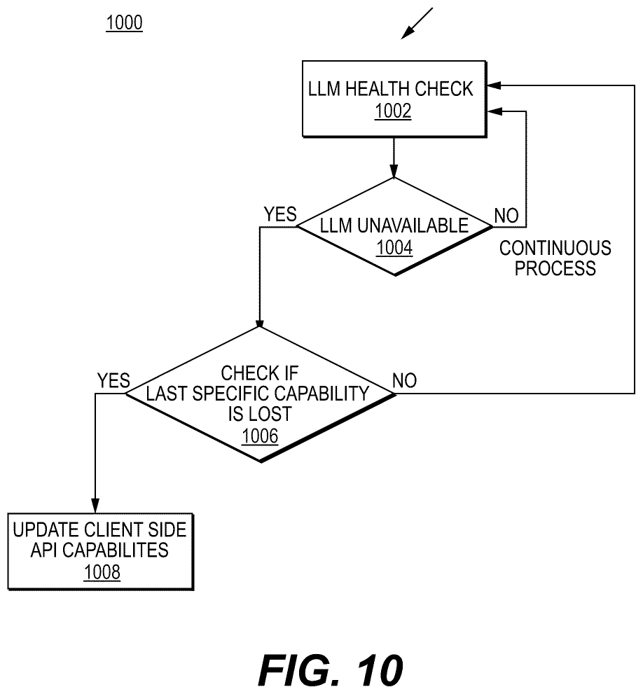

Routing system 100 may provide the response via standardized API endpoint 105. Standardized API endpoint 105 may be updated with current LLM provider capabilities (e.g., see FIG. 3 and/or FIG. 10). Standardized API endpoint 105 may provide a metrics system (e.g., see FIG. 7). Standardized API endpoint 105 may receive requested capabilities (e.g., see FIG. 8), such as in the form of flagged parameters, for example.

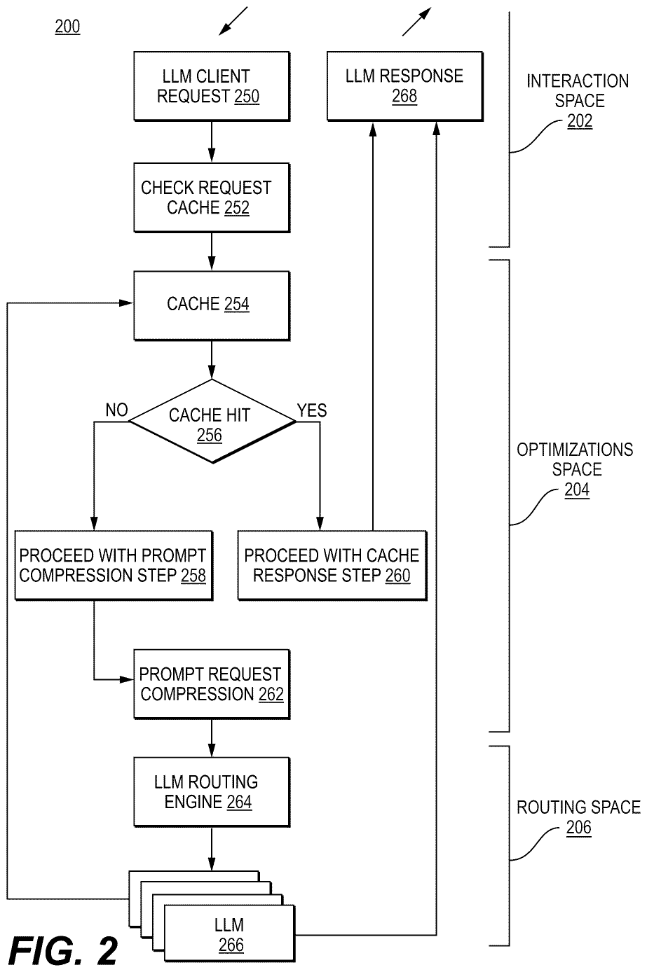

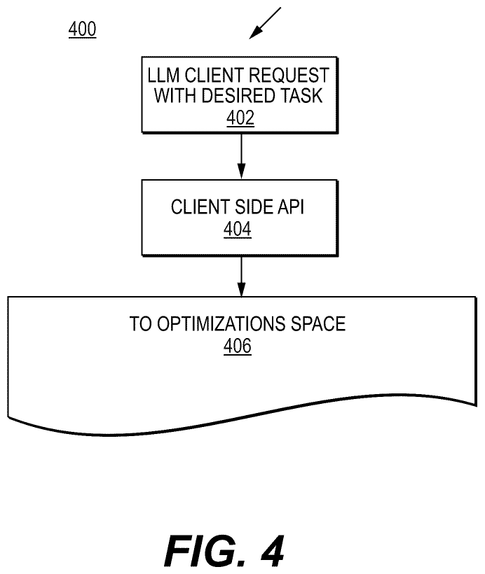

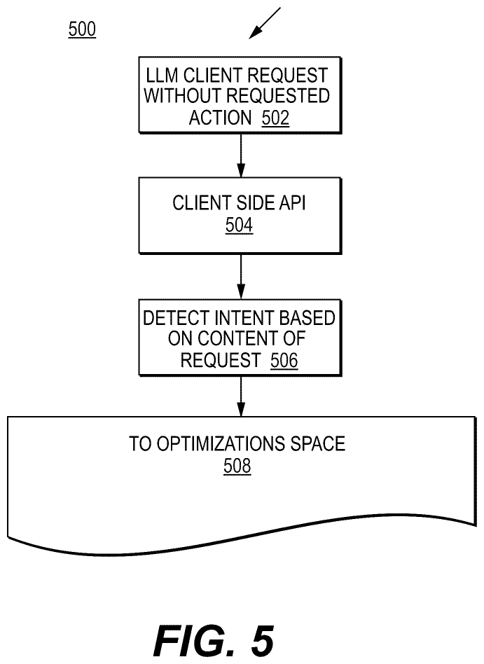

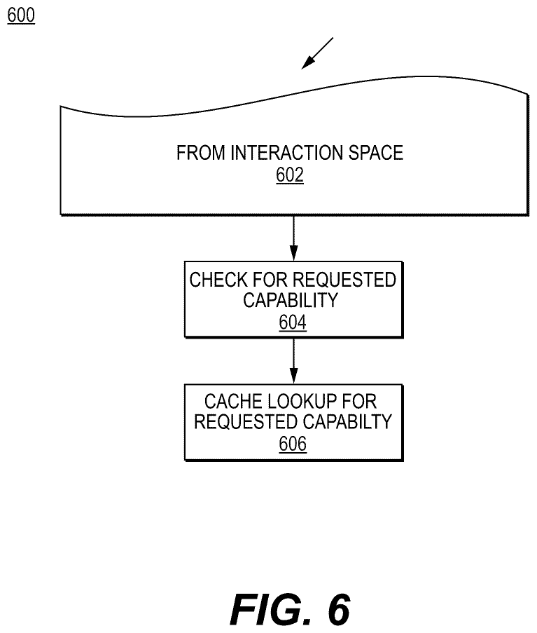

FIG. 2 depicts a flowchart of a method 200 of routing a query to a large language model provider, according to one or more embodiments. Method 200 may describe an operation of routing system 100, for example. Method 200 may include receiving an LLM client request (operation 250) in an interaction space 202, such as via standardized API endpoint 105, for example. For example, a response may be received as an industry-standardized JSON format for transporting data between 2 API endpoints. The LLM client request may include one or more express parameters, such as a parameter to perform a desired function or use a desired LLM provider (e.g., see FIG. 4, FIG. 6, and/or FIG. 8). LLM client request may not include an express parameter (e.g. see FIG. 5).

For example, an API model with request API endpoints and responses may include:

### Request:

/ai—main endpoint for LLM actions
{summarize: <Input Text>,
“options”: {“LLM”: < “XYZ”|default-auto>, “result”:<accuracy|cost|default-auto>, “randomness”: 0-100, “min_length”: X, “max_length”: X, cache: “true|false|default-true”, compress: simple char replace|method2|method3|default-simple char replace}}
   {qa: <Input Text>, “options”: {“LLM”: < “XYZ”|default-auto>, “result”:<accuracy|cost|default-auto>, “randomness”: 0-100, “min_length”: X, “max_length”: X, cache: “true|false|default-true”, compress: simple char replace|method2|method3|default-simple char replace}}
   {similar: <Input Text>, “options”: {“LLM”: < “XYZ”|default-auto>, “result”:<accuracy|cost|default-auto>, “randomness”: 0-100, “min_length”: X, “max_length”: X, cache: “true|false|default-true”, compress: simple char replace|method2|method3|default-simple char replace}}
   {sentiment: <Input Text>, “options”: {“LLM”: < “XYZ”|default-auto>, “result”:<accuracy|cost|default-auto>, “randomness”: 0-100, “min_length”: X, “max_length”: X, cache: “true|false|default-true”, compress: simple char replace|method2|method3|default-simple char replace}}
   {ner: <Input Text>, “options”: {“LLM”: < “XYZ”|default-auto>, “result”:<accuracy|cost|default-auto>, “randomness”: 0-100, “min_length”: X, “max_length”: X, cache: “true|false|default-true”, compress: simple char replace|method2|method3|default-simple char replace}}
   {translate: <Input Text>, “options”: {“LLM”: < “XYZ”|default-auto>, “result”:<accuracy|cost|default-auto>, “randomness”: 0-100, “min_length”: X, “max_length”: X, cache: “true|false|default-true”, compress: simple char replace|method2|method3|default-simple char replace}}
   {complete: <Input Text>, “options”: {“LLM”: < “XYZ”|default-auto>, “result”:<accuracy|cost|default-auto>, “randomness”: 0-100, “min_length”: X, “max_length”: X, cache: “true|false|default-true”, compress: simple char replace|method2|method3|default-simple char replace}}
/feedback—endpoint for user feedback
{id, score}—re-scoring
{id, correct answer}—fine-tuning/retraining
/capabilities—List all capabilities for integrated LLM, their capabilities and various standard benchmarks so users can choose exact LLM if they prefer

### Response:

/ai—main endpoint
{id: “id”, response: “LLM response”, routing_info{LLM used, response time, tokens used, compression ratio if enabled . . . }}
/feedback—endpoint for user feedback
{success|fail}
/capabilities

Method 200 may include storing the LLM client request in a temporary buffer (operation 252) such as a check request cache which may be a local or remote database, storage, memory, and/or the like. Method 200 may include accessing a cache (operation 254) which may be a local or remote database, storage, memory, and/or the like. Method 200 may include determining whether the LLM client request in the temporary buffer matches a stored request in cache (operation 256). For example, LLM client request may match a stored request in cache when a similarity between the LLM client request and the stored request is above a similarity threshold. Both requests (a received request and a compressed request) may be stored in persistent database or cache with a relationship, compression ratio, and response, for example. Method 200 may include checking all stored requests (received and compressed). Method 200 may include determining whether the LLM client request in the temporary buffer matches the stored request in cache using a trained machine learning model such as a machine learning model described herein, for example. When the LLM client request matches a stored request in request cache, a response associated with the matched request in request cache may be loaded as a response to LLM client request (operation 260) without sending the LLM client request to an LLM provider.

Alternatively, when the LLM client request does not match a stored request in request cache (i.e., when a similarity between the LLM client request and the stored request is below a similarity threshold), method 200 may include loading the LLM client request in a query compressor (operation 258) in an optimization space 204. The query compressor may compress (e.g., see FIG. 7) the LLM client request (operation 262). Method 200 may include determining a large language model provider, among a group of large language model providers, that best matches a capability associated with the compressed query, and providing (e.g. using an API) the compressed query to the large language model provider (operation 264) in a routing space 206. Method 200 may include determining one or more large language model providers using a trained determination machine learning model, for example.

For example, an API model with request API endpoints and responses may include:

### Request:

```
(endpoints are /ai, /feedback and /capabilities)
  /ai - main endpoint for LLM actions, there is automatic intent detection
option and exact action options for ones that want to specify exact operation like
“summarize, qa...”
  {auto: “on”|or if no option is given- select “auto mode”, ″options″:
{randomness″: 0-100,″min_length″: X, ″max_length″: X, ″cache″:
″true|false|default-true″, ″compress″: no|simple char
replace|method2|method3|default-simple char replace″, ″fallback″: ″auto|default-
off″}} - where ″auto″ option automatically detects user intent and performs
adequate operations and routing
  {summarize: <Input Text>, ″options″: {″LLM″: <″XYZ″|default-auto>,
″result″:<accuracy|cost|default-balanced>, ″randomness″: 0-100,″min_length″: X,
″max_length″: X, cache: ″true|false|default-true″, compress: no|simple char
replace|method2|method3|default-simple char replace″, ″fallback″: ″auto|default-
off″}}
  {qa: <Input Text>, ″options″: {″LLM″: <″XYZ″|default-auto>,
″result″:<accuracy|cost|default-balanced>, ″randomness″: 0-100,″min_length″: X,
″max_length″: X, cache: ″true|false|default-true″, compress: no|simple char
replace|method2|method3|default-simple char replace″, ″fallback″:
″auto|defaultoff″}}
  {similar: <Input Text>, ″options″: {″LLM″: <″XYZ″|default-auto>,
″result″:<accuracy|cost|default-balanced>, cache: ″true|false|default-true″,
compress: no|simple char replace|method2|method3|default-simple char
replace″, ″fallback″: ″auto|default-off″} }
  {sentiment: <Input Text>, ″options″: {″LLM″: <″XYZ″|default-auto>,
″result″:<accuracy|cost|default-balanced>, cache: ″true|false|default-true″,
compress: no|simple char replace|method2|method3|default-simple char
replace″, ″fallback″: ″auto|default-off″}}
  {ner: <Input Text>, ″options″: {″LLM″: <″XYZ″|default-auto>,
″result″:<accuracy|cost|default-balanced>, cache: ″true|false|default-true″,
compress: no|simple char replace|method2|method3|default-simple char
replace″, ″fallback″: ″auto|default-off″} }
  {translate: <Input Text>, ″options″: {″LLM″: <″XYZ″|default-auto>,
″result″:<accuracy|cost|default-balanced>, ″randomness″: 0-100,″min_length″: X,
″max_length″: X, cache: ″true|false|default-true″, compress: no|simple char
replace|method2|method3|default-simple char replace″, ″fallback″: ″auto|default-
off″}}
  {complete: <Input Text>, ″options″: {″LLM″: <″XYZ″|default-auto>,
″result″:<accuracy|cost|default-balanced>, ″randomness″: 0-100,″min_length″: X,
″max_length″: X, cache: ″true|false|default-true″, compress: no|simple char
replace|method2|method3|default-simple char replace″, ″fallback″: ″auto|default-
off″}}
/feedback - endpoint for user feedback
  {id, score} - re-scoring
  {id, correct answer} - fine-tuning / retraining
/capabilities - List all capabilities for integrated LLM, their capabilities and various
standard benchmark/score metrics so users can choose exact LLM if they prefer
```

### Response:

```
/ai - main endpoint
Response from some text based models
{id: “id”, response: “LLM response”, routing_info{LLM used, response time,
tokens used, compression ratio if enabled...}} response, for instance, for image or
music generation may be image or music with a system response ID
/feedback - endpoint for user feedback
{success|fail}
/capabilities
Example of integrated LLMs with capabilities, metrics, status and so on
{ “models”: [ { “name”: “GPT-3”, “description”: “Generative Pre-trained
Transformer 3”, “Cost metric”: “token”, “Cost”: “0.03”,
“Average user score”: “X”, “capabilities”: [ “Textgen”, “Text generation”,
“Language translation”, “Text completion”, “Text summarization”, “Question
answering”, “Chatbot functionality” ],
“metrics”: [
{
“ROUGE”: “123”,
“BLEU”: “456”,
“METEOR”: “789”,
“COMET”: “999”,
“BERT”: “999”,
}
],
“status”: [ { “Reachable”: “true”, “Enabled”: “false” } ], “api_link”:
“https://openai.com/gpt-3” },
  { “name”: “GPT-4”, “description”: “Generative Pre-trained Transformer 4”, “Cost
metric”: “token”, “Cost”: “0.06”,
“Average user score”: “X”,
  “capabilities”: [ “Textgen”, “Text generation”, “Language translation”, “Text
completion”, “Text summarization”, “Question answering”, “Chatbot functionality”
],
“metrics”: [
{
“ROUGE”: “123”,
“BLEU”: “456”,
“METEOR”: “789”,
“COMET”: “999”,
“BERT”: “999”,
}
],
  “status”: [ { “Reachable”: “true”, “Enabled”: “true” } ], “api_link”:
“https://openai.com/gpt-4” },
{ “name”: “BERT”, “description”: “Bidirectional Encoder Representations from
Transformers”, “Cost metric”: “token”, “Cost”: “0.03”,
“Average user score”: “X”,
  “capabilities”: [ “Natural language understanding”, “Text classification”,
“Named entity recognition”, “Text summarization”, “Question answering” ],
“metrics”: [
{
“ROUGE”: “123”,
“BLEU”: “456”,
“METEOR”: “789”,
“COMET”: “999”,
“BERT”: “999”,
}
],
“status”: [ { “Reachable”: “true”, “Enabled”: “false” } ],”api_link”:
“https://github.com/google-research/bert” },
```

The one or more determined large language models may receive the compressed query and may process the compressed query. The processing may include determining and outputting a response to the compressed query. The response may be generated based on, for example, providing the compressed query or a decompressed version of the compressed query to an LLM machine learning model such as an artificial neural network. The LLM machine learning model may be trained using self-supervised learning, semi-supervised learning, and/or unsupervised learning. According to an example, the LLM machine learning model may repeatedly predict a next token, term, word, or other applicable output based on the input query.

The one or more determined large language model providers may return a response, which may be stored in cache and loaded as a response to the LLM client request (operation 266). Method 200 may include providing one or more of the response from the one or more large language model providers (from operation 266) or the response associated with the matched request from operation 260 (operation 268).

FIG. 3 depicts a flowchart of a method 300 of generating dynamic client exposed API capability based on integrated model capabilities of a large language model provider routing system, according to one or more embodiments. Method 300 may include receiving a notification of capabilities of a large language model provider (operation 302). For example, the notification may be one or more of an indication that a new capability has been added, a list of multiple capabilities of an LLM provider, or a single new capability of an LLM provider. Method 300 may include determining whether the new capability is already accessible by the client side API (e.g. see API example above) (operation 304). When the new capability is determined to already be accessible by the client side API, method 300 may include making no change to the client side API (operation 306). When the new capability is determined to not already be accessible by the client side API, method 300 may include updating the client side API to include the new capability of the LLM provider (operation 308), and providing the updated client side API to users (operation 310).

FIG. 4 depicts a flowchart of a method 400 of routing a query to a large language model provider, according to one or more embodiments. Method 400 may include receiving an LLM client request that includes a desired task (operation 402) and providing an indication of receipt via the client side API (operation 404). The desired task, or intent, may be provided by the user via an interface associated with the client side API or may be automatically generated based on a query (e.g., based on query properties). The interface may include adjustable weighting factors for least cost, best quality, and/or best accuracy, for example. The interface may include selectable LLM providers, for example. Method 400 may include proceeding through the interaction space 202 and optimization space 204 and method 200 with the LLM client request, as shown beginning with operation 252, for example (operation 406).

FIG. 5 depicts a flowchart of a method 500 of analyzing content of a request to a large language model provider routing system, according to one or more embodiments. Method 500 may include receiving an LLM client request that does not include a desired task (operation 502) and providing an indication of receipt via the client side API (operation 504). Method 500 may include detecting a desired intent of the LLM client request based on a content of the LLM client request (operation 506). For example, LLM client request may be “provide a summary using ACME LLM with a funny style,” a first intent may be detected as “use ACME LLM,” and a second intent may be detected as “funny style.” Method 500 may include detecting the desired intent (see example API above) of the LLM client request using a trained machine learning model such as one or more machine learning models described herein, for example. For example, automatically detecting intent and named entities may depend on an end-user following concise input guidelines. Method 500 may include proceeding through interaction space 202 and optimization space 204 and method 200 with the LLM client request, as shown beginning with operation 252, for example (operation 508).

FIG. 6 depicts a flowchart of a method 600 of a cache lookup in a large language model provider routing system, according to one or more embodiments. Method 600 may include receiving an LLM client request in interaction space 202 (operation 602). Method 600 may include checking whether a requested capability in the LLM client request is available in multiple LLM providers (operation 604). Method 600 may include checking whether a requested capability in the LLM client request is available in cache (operation 606). For example, a cache may store capabilities and standardized metric scores in a database or as a standard-based JSON text object.

FIG. 7 depicts a flowchart of a method 700 of compressing a request to a large language model provider routing system, according to one or more embodiments. Method 700 may include compressing an LLM client request (operation 702). Method 700 may include compressing an LLM client request using a trained machine learning model such as one or more machine learning models described herein, for example. Method 700 may include determining whether the compression was successful (operation 704). When the compression is determined to be unsuccessful, method 700 may include proceeding through routing space 206 and method 200 with the uncompressed LLM client request, as shown beginning with operation 264, for example (operation 708). When the compression is determined to be successful, method 700 may include reporting a difference (e.g. between tokens, where a token may be one or more of a word, a group of words, punctuation, or part of a word) between the uncompressed LLM client request (i.e. the request as received) and the compressed LLM client request to an integrated or separate metrics system (operation 706). According to ChatGPT LLM tokenizer, some general rules of thumb for defining tokens are: 1 token ˜=4 chars in English. 1 token ˜=¾ words”. For example, a token may be defined as described in https://deepchecks.com/5-approaches-to-solve-llm-token-limits/, which is incorporated herein by reference. For example, the metrics system may provide one or more of usage, cost tracking, or savings tracking. Method 700 may include proceeding through routing space 206 and method 200 with the compressed LLM client request, as shown beginning with operation 264, for example (operation 708).

FIG. 8 depicts a flowchart of a method 800 of routing a query to a large language model provider, according to one or more embodiments. Method 800 may include receiving an LLM client request in optimization space 204 (operation 802). Method 800 may include checking whether a requested parameter in the LLM client request is available in multiple LLM providers (operation 804). Method 800 may include determining a large language model provider, among a group of large language model providers, which best matches a capability associated with the requested parameter (operation 806). The determination may be based on an overall determination score or one or more category based determination scores, as described herein. Method 800 may include routing the LLM client request to the large language model provider, among a group of large language model providers, which best matches a capability associated with the requested parameter (operation 808).

For example, a user may request a sentiment response/analysis by invoking an/ai endpoint with options:

### Defaults for Sentiment Analysis Option:

{sentiment: <Input Text>, “options”: {“LLM”: < “XYZ”|default-auto>, “result”:<accuracy|cost|default-balanced>, cache: “true|false|default-true”, compress: simple char replace|method2|method3|default-simple char replace}}
>>> CLIENT REQUEST—GET/ai
{sentiment: “High quality pants. Very comfortable and great for sport activities. Good price for nice quality! I recommend to all fans of sports” options”: {“result”:accuracy, compress: no}}
<<< Response
{id: 1234567890, response: “{Positive: 99.1%}”, routing_info{“twitter-roberta-base-sentiment-latest”, 1000 ms, 33, compression ratio: none used}}

For example, an internal process may include: (1) tag request with random ID tag, (2) select LLMs with capability=sentiment, (3) check if to use cache or not as requested by client—if none provided, default is use cache for this combination of LLM/capabilities, (4) check to use Compression or not as requested by client—if none is provided default is compress with minimal loss, (5) select LLM by metric score (Client selected accuracy in options so select one LLM with metric that describes best accuracy for this capability), (6) forward client's request to selected LLM, (7) receive LLM response, (7) respond to Client that requested this action along with same ID.

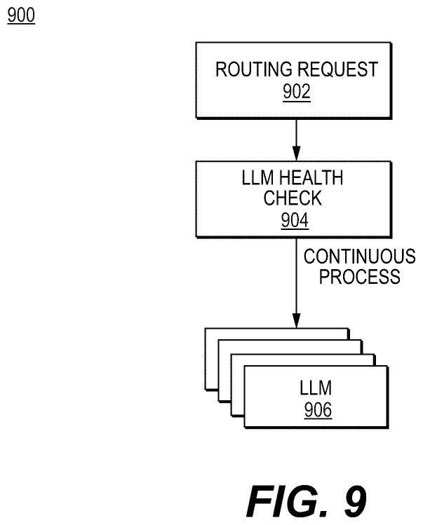

FIG. 9 depicts a flowchart of a method 900 for checking health of a large language model provider routing system, according to one or more embodiments. Method 900 may include receiving an LLM client request along with a routing request (operation 902). Method 900 may include performing a health check of the large language model provider associated with the routing request (operation 904). For example, a health check may include an API endpoint for an LLM with a response of “OK” or “NOT OK” with an optional description for a “NOT OK” response. For example, method 900 may provide the modified query to a fallback large language model provider if a first provider does not respond quickly (e.g. within a threshold time). Method 900 may include providing the LLM client request to the large language model provider (operation 906).

FIG. 10 depicts a flowchart of another method 1000 for checking health of a large language model provider routing system, according to one or more embodiments. Method 1000 may include performing a health check of a plurality of large language model providers (operation 1002). Method 1000 may include determining whether a large language model provider is unavailable (operation 1004). In operation 1004, when the large language model provider is determined to be available, method 1000 may include periodically performing the health check of the plurality of large language model providers in operation 1002. In operation 1004, when the large language model provider is determined to be unavailable, method 1000 may include checking whether a capability of the large language model provider has changed (operation 1006). In operation 1006, when a capability of the large language model provider is determined not to have changed, method 1000 may include periodically performing the health check of the plurality of large language model providers in operation 1002. In operation 1006, when a capability of the large language model provider is determined to have changed, method 1000 may include updating the client side API with the changed capabilities of the large language model provider (operation 1008). For example, method 1000 may include querying available capabilities of a list in a back-end system of all integrated LLMs. When a capability of an LLM is determined to change, the LLM may be removed from the list of LLMs having the capability. Method 1000 may check whether any LLMS remain for the capability. If no LLMs remain with the capability, method 1000 may remove the capability option from the client side API, and if LLMs remain with the capability, the capability set that is exposed the client side API stays the same.

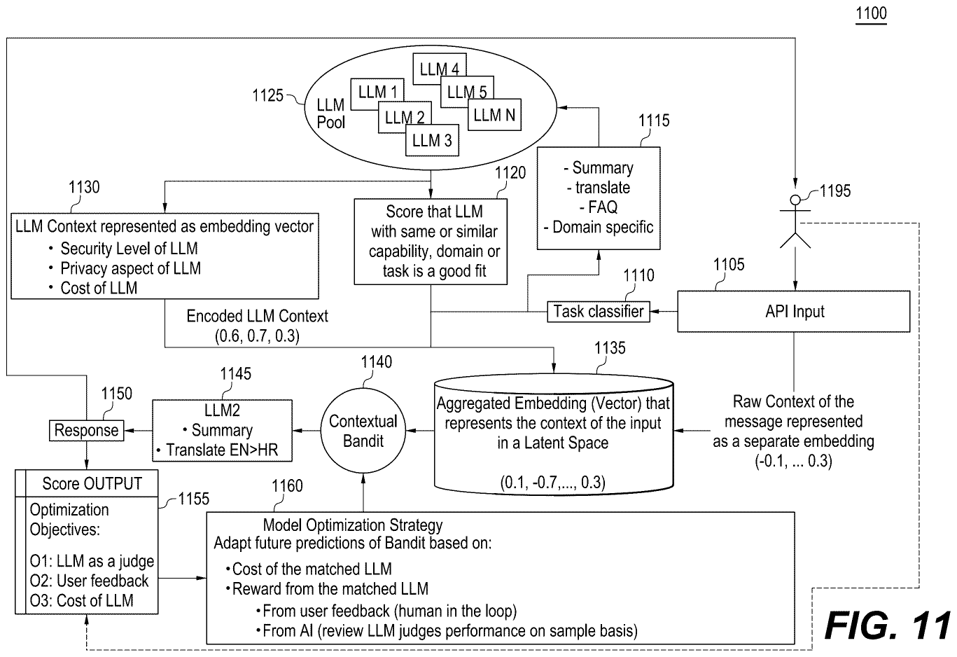

FIG. 11 depicts an exemplary system infrastructure for a large language model provider routing system, according to one or more embodiments. As depicted in FIG. 11, a router, or routing system, 1100 may include various components. Routing system 1100 may include or communicate with LLM providers in LLM pool 1125. LLM providers may be one or more of a cloud LLM provider or a local LLM model. Any applicable number of LLM providers may be applied to embodiments disclosed herein. Routing system 1100 may include standardized API input 1105, task classifier 1110, LLM scorer 1120, LLM context generator 1130, aggregator 1135, contextual bandit 1140, standardized API output 1150, output scorer 1155, and model optimizer 1160.

Standardized API input 1105 may receive a query from user 1195, for example. The query may be a request for a text summarization, for example. However, the disclosure is not limited thereto, and may include any query suitable for input to an LLM. For example, the query may be an element of a chatbot (e.g., a conversational agent or analytical agent). Standardized API input 1105 may provide the query to task classifier 1110. Task classifier 1110 may generate a classification 1115 for the query from among a plurality of classifications. Classification 1115 may be task such as a text summary, a translation, an FAQ, or a domain-specific task, for example. Routing system 1100 may use the generated classification 1115 to reduce a number of potential LLMs into a subset, among a larger set of LLM providers in LLM pool 1125, which are most suited to respond to the query.

Task classifier 1110 may be a machine learning model. Task classifier 1110 may receive the query as an input and may output one or more classifications. Task classifier 1110 may be trained in accordance with techniques disclosed herein with respect to one or more other machine learning models. For example, task classifier 1110 may be trained based on historical or simulated queries and/or historical or simulated classifications associated with such historical or simulated queries. One or more weights, layers, nodes, synapsis, biases, or weights may be adjusted based on such historical or simulated data that may, for example, be tagged. Accordingly, a trained task classifier 1110 may receive the input from standardized API input 1105 and may process the input via the one or more weights, layers, nodes, synapsis, biases, or weights. Task classifier 1110 may output a classification 1115 that most correlates with a given classification from a set of classifications. For example, task classifier 1110 may apply a correlation score for each of a subset of potential classifications. Task classifier 1110 may output the classification 1115 that corresponds to the highest correlation score.

LLM scorer 1120 may generate a score for each LLM in the subset of potential LLMs in LLM pool 1125 as reduced by the generated classification 1115. The score may correlate with a probability that each LLM is a good fit for the query. A good, or best, fit may refer to using the most optimal LLM for a respective task that is being solved. The “best fit” may be based on a multi-objective optimization that is learned within the selected optimization strategy (e.g., cost of LLM, reward from matched LLM) as depicted in FIG. 11 (e.g., with model optimizer 1160). For example, the score may correlate domain-specific LLMs with a domain-specific query, or may correlate translation LLMs with a translation request. LLM context generator 1130 may generate a context for each LLM in the subset of potential LLMs. The LLM contexts may contain information regarding a context of each LLM, such as one or more of a security level (e.g., local network only, clearance level, or security protocols), privacy aspect, efficiency, preference, or cost, for example. For example, a smaller LLM may have a lower cost and a higher efficiency (e.g., faster response) than a larger LLM, for example. The LLM contexts may be provided as a vector, such as (0.6, 0.7, 0.3) where a security level of an LLM is 0.6, a privacy aspect of an LLM is 0.7, and a security cost of an LLM is 0.3, on a scale from 0 to 1.

Aggregator 1135 may generate an aggregation of the query from standardized API input 1105, the classification for the query from task classifier 1110, the LLM scores from LLM scorer 1120, and the LLM contexts from LLM context generator 1130. Each of the query from standardized API input 1105, the classification for the query from task classifier 1110, the LLM scores from LLM scorer 1120, and the LLM contexts from LLM context generator 1130 may be represented as a respective vector, for example. Aggregator 1135 may generate an aggregation vector from the respective vectors. Aggregator 1135 may provide the aggregation (e.g., as the aggregation vector) to contextual bandit 1140.

Contextual bandit 1140 may select an LLM 1145 from among the subset of LLMs from aggregator 1135, based on the aggregation from aggregator 1135 and strategies from model optimizer 1160. Contextual bandit 1140 may use information in the aggregation from aggregator 1135. The aggregation from aggregator 1135 may be created by combining standardized API input 1105, the output of LLM scorer 1120, and the output of LLM context generator 1130. These individual information sources may be provided to contextual bandit 1140 as one concatenated vector in order to make a decision, or prediction. For example, data from such information sources (e.g., API input 1105, the output of LLM scorer 1120, and/or the output of LLM context generator 1130) may be provided from such sources in respective first formats. The data may be converted into a concatenated vector at the contextual bandit 1140 or at a separate component prior to being provided to the contextual bandit 1140. The conversion may include normalizing the data into a concatenated format or otherwise harmonizing the data to generate the concatenated vector. The optimal LLM may be chosen by calculating a score (e.g. by using an Upper Confidence Bound or other related scoring methods) for each LLM. The appropriate LLM may then be chosen as the LLM with the highest score based on the provided feature vector for the aggregation from aggregator 1135. Contextual bandit 1140 may maintain a context matrix for each LLM by incrementally updating the context matrix with the outer product of observed feature vectors. This may allow model optimizer 1160 to capture the influence of features in relation to received rewards over time.

Model optimizer 1160 may be a separate component from contextual bandit 1140 or integrated into contextual bandit 1140. Model optimizer 1160 may provide one or more inputs to contextual bandit 1140 based on various factors, such as a cost of the selected LLM 1145 and/or a score from output scorer 1155 (further discussed herein), for example. Model optimizer 1160 may provide a model optimization strategy (e.g., via one or more scores, weights, etc.) to contextual bandit 1140 based on one or more of request throughput, cost of using the large language model provider, or quality of the response.

The model optimization strategy may include a prediction that estimates potential improvements in model performance due to further training or fine-tuning, and balancing exploration and exploitation in the determining by generating an upper confidence bound for each large language model in the subset of large language model providers. The model optimization strategy may include change detection to determine convergence points where a performance of the contextual bandit 1140 stabilizes, using sliding windows and thresholding to compare predicted rewards from different time windows, and adjusting the determining based on the predicted rewards.

Contextual bandit 1140 may provide the query to the selected LLM 1145, receive a response from the selected LLM 1145, and provide the response to user 1195 via standardized API output 1150. The response from the selected LLM 1145 may be scored by output scorer 1155. Output scorer 1155 may provide the score to model optimizer 1160. The score may be based on various factors including one or more of a periodic scoring of the response from the selected LLM 1145 by a review LLM, feedback from user 1195, or a cost of the selected LLM 1145. The score may be a weighted score of a periodic scoring of the response from the selected LLM 1145 by a review LLM, feedback from user 1195, and a cost of the selected LLM 1145. The review LLM may be a classification task which returns 1 (good) or 0 (bad or neutral), for example, and may be any number which improves the performance of contextual bandit 1140. User feedback may be similar to a thumbs up, neutral, or thumbs down scenario (e.g., −1, 0, 1). The cost may be an actual number that indicates the cost (in some reference currency) for the given query. The cost may be normalized to fit in an interval of [0,1], but the disclosure is not limited thereto.

Routing system 1100 may receive a query via standardized API input 1105, and may compress the received query to reduce a number of tokens, such as a number of words, characters, bits, redundancies, etc., for example, in or associated with the query. Compressing the query may include removing one or more tokens from the query. Compressing the query may reduce one or more of storage costs, processing time, or LLM provider costs, for example. Routing system 1100 may process one or more of the received query or the compressed query.

Routing system 1100 may determine routing based on one or more of least cost, fallback, best quality, or best accuracy, for example. Routing system 1100 may determine routing based on a feature requested, including one or more of text generation, language translation, text completion, summarizations, question answering, chatbot functionality, or image generation (e.g., requested as part of or as a supplement to the query). LLM capabilities may include, but are not limited to, a query format (e.g., a question, a pattern request, a trend request, a task request, a summary request, etc.), a sentiment associated with the query, a content type (e.g., image, chart, text, video, audio, etc.), an analysis type (e.g., historical analysis, data analysis, etc.), a computation, and/or the like.

Alternatively, or in addition, a query may be segmented using a segmentation model. The query may be segmented based on query structure, terms or content associated with the query, and/or the like. The segmentation model may assign weights to different segments of the query based on predetermined or dynamically determined rules applied to the query. The segmentation model may output a segmentation score for each or a subset of the segments. The segmentation scores for each or all of the segments may be correlated with capabilities such that one or more capabilities with a segmentation score above a given threshold may be associated with the query. Query capabilities may be matched with one or more LLM model capabilities to select optimal LLM models for the query.

Contextual bandit 1140 may be a machine learning model trained based on historical or simulated queries, historical or simulated LLM selections, historical or simulated LLM outputs, and/or the like (“training data”). The training data may be applied to a machine learning algorithm to train the machine learning model. The training may include initializing, updating, and or adjusting one or more weights, layers, biases, nodes, synapses or the like of the machine learning model based on the model training data and/or training algorithm. Contextual bandit 1140 may be configured to receive, as inputs, the aggregation from aggregator 1135 and strategies from model optimizer 1160, and may further be configured to receive inputs such as, but not limited to, client information, cached queries, current event information, and or the like. Contextual bandit 1140 may apply one or more of the inputs to output one or more LLM models. For example, contextual bandit 1140 may apply the inputs to one or more layers, weights, biases, synapses, or nodes to output one or more LLM models.

Accordingly, embodiments disclosed herein are directed to improving LLM technology. In accordance with these embodiments, a client may be able to utilize one or more of a plurality of LLM models most applicable to a client query. The one or more of the plurality of LLM models may be identified in a cost and resource efficient manner by matching queries to applicable LLM models. A plurality of available LLM models may be filtered such that only applicable LLM models are used to respond to a given query. Such filtering and LLM model determination makes use of a multiple LLM model system faster than conventional techniques. For example, embodiments disclosed herein allow for faster query response using applicable LLM models rather than a trial and error system.

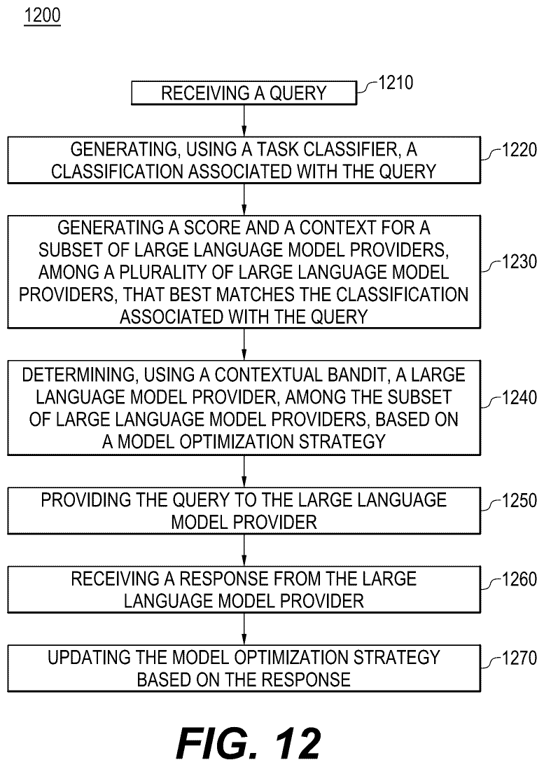

FIG. 12 depicts a flowchart of a method for determining a large language model provider routing system, according to one or more embodiments. Method 1200 may include various operations.

Method 1200 may include receiving a query (operation 1210), such as via standardized API input 1105, for example. Method 1200 may include generating, using a task classifier (e.g., task classifier 1110), a classification (e.g., classification 1115) associated with the query (operation 1220). The classification may be one or more of a text summary, a translation, an FAQ, or a domain-specific task, for example. Method 1200 may include generating a score and a context (e.g., LLM scorer 1120) for a subset of large language model providers, among a plurality of large language model providers (e.g., LLM pool 1125), that provides a highest correlation with the classification associated with the query (operation 1230). The context may include one or more of a security level, privacy aspect, efficiency, preference, or cost. One or more of the classification, score, or context may be provided as a vector.

Method 1200 may include determining, using a contextual bandit (e.g., contextual bandit 1140), a large language model provider, among the subset of large language model providers, based on a trained model (e.g., model optimizer 1160) for the contextual bandit (operation 1240). One or more of the task classifier or the contextual bandit is a machine learning model.

The trained model for the contextual bandit may be trained using one or more of request throughput, cost of using the large language model provider, or quality of the response. The trained model for the contextual bandit may be trained (e.g., incrementally over time) using a prediction that estimates potential improvements in model performance due to further training or fine-tuning, and balancing exploration and exploitation in the determining by generating an upper confidence bound, or other scoring method, for each large language model in the subset of large language model providers. The trained model for the contextual bandit may be trained using a change detection to determine convergence points where a performance of the contextual bandit stabilizes, using sliding windows and thresholding to compare predicted rewards from different time windows, and adjusting the determining based on the predicted rewards.

The trained model for the contextual bandit may be trained using a reward score based on the response from the large language model provider, and using the reward score as feedback in the contextual bandit to refine the determining the large language model provider. The reward score may be a weighted score of one or more of a periodic scoring of the response from the large language model provider by a review large language model provider, feedback from a user, or a cost of the large language model provider.

Method 1200 may include providing the query to the large language model provider (e.g., selected LLM 1145) (operation 1250). Method 1200 may include receiving a response from the large language model provider (operation 1260). Method 1200 may include updating the trained model for the contextual bandit based on the response (operation 1270). Method 1200 may further include providing the response from the large language model provider.

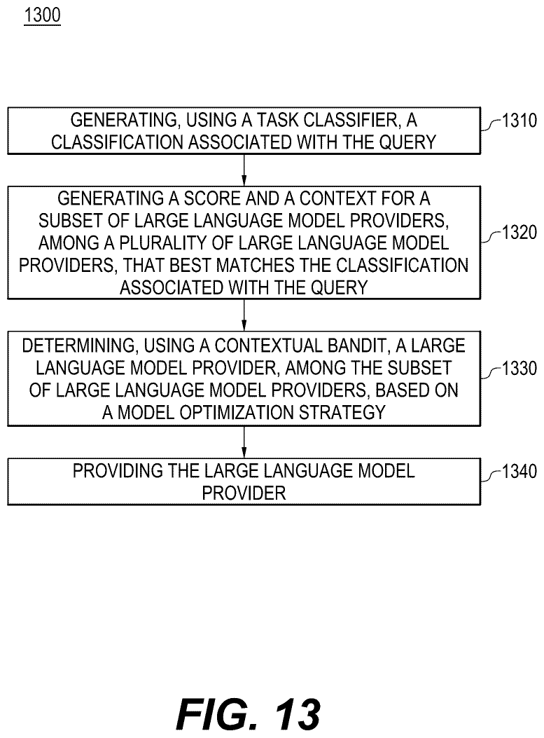

FIG. 13 depicts a flowchart of a method for providing a large language model provider routing system, according to one or more embodiments. Method 1300 may include various operations.

Method 1300 may include generating, using a task classifier (e.g., task classifier 1110), a classification (e.g., classification 1115) associated with a query (operation 1310). Method 1300 may include generating a score and a context (e.g., LLM scorer 1120) for a subset of large language model providers, among a plurality of large language model providers (e.g., LLM pool 1125), that provides a highest correlation with the classification associated with the query (operation 1320). Method 1300 may include determining, using a contextual bandit (e.g., contextual bandit 1140), a large language model provider, among the subset of large language model providers, based on a trained model (e.g., model optimizer 1160) for the contextual bandit (operation 1330). Method 1300 may include providing (e.g., via standardized API output 1150) the large language model provider (operation 1340).

Method 1300 may further include providing the query to the large language model provider, receiving a response from the large language model provider, and updating the trained model for the contextual bandit based on the response. Updating the trained model for the contextual bandit may include one or more of: providing the response to a review large language model provider and receiving a review score from the review large language model provider, generating a feedback score based on feedback from a user for the response, or generating a cost score based on a cost of the response from the large language model provider.

The contextual bandit may include a trained machine learning model. Updating the trained model for the contextual bandit may include training the machine learning model of the contextual bandit. Method 1300 may further include aggregating the classification, the score, the context, and the query as a vector; and providing the vector to the contextual bandit to determine the large language model provider.

In general, any process or operation discussed in this disclosure may be computer-implementable, such as the systems and/or processes illustrated in FIGS. 1-13, and may be performed by one or more processors of a computer system. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices. One or more processors of a computer system may be included in a single computing device or distributed among a plurality of computing devices. A memory of the computer system may include the respective memory of each computing device of the plurality of computing devices.

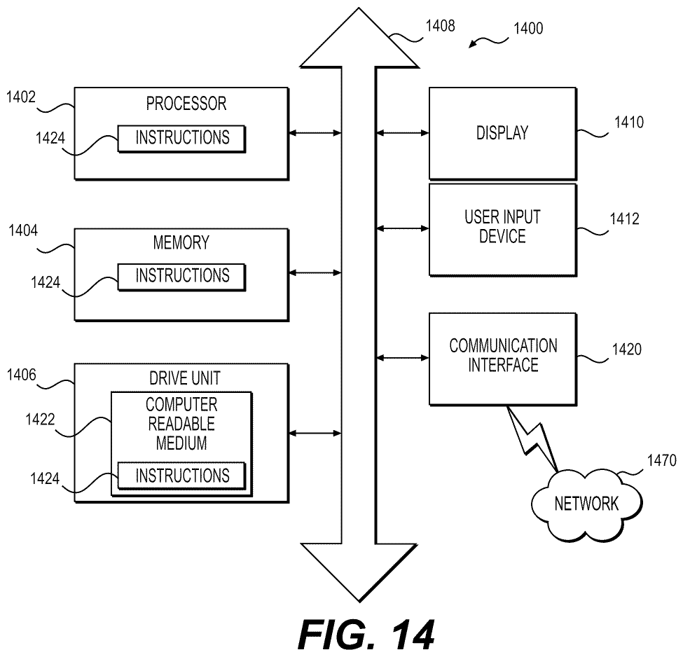

FIG. 14 is a simplified functional block diagram of a computer system 1400 that may be configured as a device for executing the techniques disclosed herein, according to exemplary embodiments of the present disclosure. Computer system 1400 may generate features, statistics, analysis, and/or another system according to exemplary embodiments of the present disclosure. In various embodiments, any of the systems (e.g., computer system 1400) disclosed herein may be an assembly of hardware including, for example, a data communication interface 1420 for packet data communication. The computer system 1400 also may include a central processing unit (“CPU”) 1402, in the form of one or more processors, for executing program instructions 1424. The computer system 1400 may include an internal communication bus 1408, and a storage unit 1406 (such as ROM, HDD, SDD, etc.) that may store data on a computer readable medium 1422, although the computer system 1400 may receive programming and data via network communications (e.g., over a network 1470). The computer system 1400 may also have a memory 1404 (such as RAM) storing instructions 1424 for executing techniques presented herein, although the instructions 1424 may be stored temporarily or permanently within other modules of computer system 1400 (e.g., processor 1402 and/or computer readable medium 1422). The computer system 1400 also may include input and output ports 1412 and/or a display 1410 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device.

Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

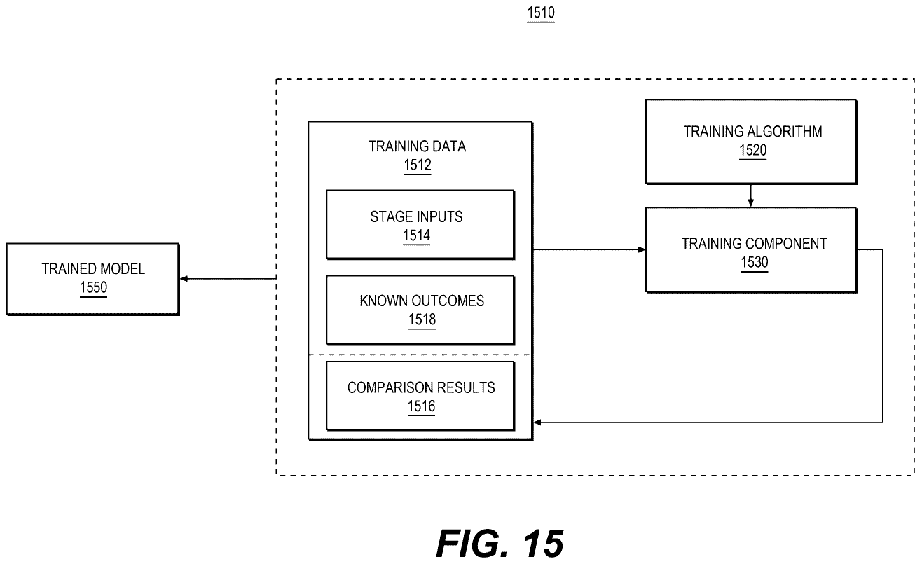

As disclosed herein, one or more implementations disclosed herein may be applied by using a machine learning model. A machine learning model as disclosed herein may be trained using one or more components or operations of FIGS. 1-13. As shown in flow diagram 1510 of FIG. 15, training data 1512 may include one or more of stage inputs 1514 and known outcomes 1518 related to a machine learning model to be trained. The stage inputs 1514 may be from any applicable source including a component or set shown in the figures provided herein. The known outcomes 1518 may be included for machine learning models generated based on supervised or semi-supervised training. An unsupervised machine learning model might not be trained using known outcomes 1518. Known outcomes 1518 may include known or desired outputs for future inputs similar to or in the same category as stage inputs 1514 that do not have corresponding known outputs.

A process of fine-tuning LLMs that can be fine-tuned may be described by some form of unsupervised machine learning where feedback responses that are providing correct answer are fed to a fine-tuning process. That process may encompass a small percentage (e.g. from approximately 15% to approximately 20%) of received feedback responses to be checked by humans to be sure that no intentionally wrong answers are being fed to the system and to have some form of human in the loop. An additional process that may involve machine learning may be intent and/or action detection when using the service in an “auto” mode.

The training data 1512 and a training algorithm 1520 may be provided to a training component 1530 that may apply the training data 1512 to the training algorithm 1520 to generate a trained machine learning model 1550. According to an implementation, the training component 1530 may be provided comparison results 1516 that compare a previous output of the corresponding machine learning model to apply the previous result to re-train the machine learning model. The comparison results 1516 may be used by the training component 1530 to update the corresponding machine learning model. The training algorithm 1520 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like.

A machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

One or more embodiments may provide an LLM or any Gen-AI request routing according to competence levels and capabilities. One or more embodiments may provide automatic intent detection for routing without knowing anything about any LLM or any Gen-AI capabilities. One or more embodiments may provide a feedback loop to rescore or fine-tune LLMs based on client feedback. One or more embodiments may provide automatic client API reconfiguration based on integrated LLM or Gen-AI model capabilities.

While the presently disclosed methods, devices, and systems are described with exemplary reference to transmitting data, it should be appreciated that the presently disclosed embodiments may be applicable to any environment, such as a desktop or laptop computer, a mobile device, a wearable device, an application, or the like. In addition, the presently disclosed embodiments may be applicable to any type of Internet protocol.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method comprising:
receiving a query;
generating, using a task classifier, a classification associated with the query;
generating a score and a context for a subset of large language model providers, among a plurality of large language model providers, that provides a highest correlation with the classification associated with the query;
determining, using a contextual bandit, a large language model provider, among the subset of large language model providers, based on a trained model for the contextual bandit;
providing the query to the large language model provider;
receiving a response from the large language model provider; and
updating the trained model for the contextual bandit based on the response.

2. The method of claim 1, further comprising:
providing the response from the large language model provider.

3. The method of claim 1, wherein the trained model for the contextual bandit is trained using one or more of request throughput, cost of using the large language model provider, or quality of the response.

4. The method of claim 1, wherein the trained model for the contextual bandit is trained using a prediction that estimates potential improvements in model performance due to further training or fine-tuning, and balancing exploration and exploitation in the determining by generating an upper confidence bound for each large language model in the subset of large language model providers.

5. The method of claim 1, wherein the trained model for the contextual bandit is trained using a change detection to determine convergence points where a performance of the contextual bandit stabilizes, using sliding windows and thresholding to compare predicted rewards from different time windows, and adjusting the determining based on the predicted rewards.

6. The method of claim 1, wherein the trained model for the contextual bandit is trained using a reward score based on the response from the large language model provider, and using the reward score as feedback in the contextual bandit to refine the determining the large language model provider.

7. The method of claim 6, wherein the reward score is a weighted score of one or more of a periodic scoring of the response from the large language model provider by a review large language model provider, feedback from a user, or a cost of the large language model provider.

8. The method of claim 1, wherein the classification is one or more of a text summary, a translation, an FAQ, or a domain-specific task.

9. The method of claim 1, wherein one or more of the task classifier or the contextual bandit is a machine learning model.

10. The method of claim 1, wherein the context includes one or more of a security level, privacy aspect, efficiency, preference, or cost.

11. The method of claim 1, wherein one or more of the classification, score, or context is provided as a vector.

12. A method comprising:
generating, using a task classifier, a classification associated with a query;
generating a score and a context for a subset of large language model providers, among a plurality of large language model providers, that provides a highest correlation with the classification associated with the query;
determining, using a contextual bandit, a large language model provider, among the subset of large language model providers, based on a trained model for the contextual bandit; and
providing the large language model provider.

13. The method of claim 12, further comprising:
providing the query to the large language model provider;
receiving a response from the large language model provider; and
updating the trained model for the contextual bandit based on the response.

14. The method of claim 13, wherein the updating the trained model for the contextual bandit includes one or more of:
providing the response to a review large language model provider and receiving a review score from the review large language model provider,
generating a feedback score based on feedback from a user for the response, or
generating a cost score based on a cost of the response from the large language model provider.

15. The method of claim 13, wherein the contextual bandit includes a trained machine learning model.

16. The method of claim 15, wherein the updating the trained model for the contextual bandit includes training the machine learning model of the contextual bandit.

17. The method of claim 12, further comprising:
aggregating the classification, the score, the context, and the query as a vector; and
providing the vector to the contextual bandit to determine the large language model provider.

18. A system comprising one or more processors configured to execute a method including:
receiving a query;
generating, using a task classifier, a classification associated with the query;
generating a score and a context for a subset of large language model providers, among a plurality of large language model providers, that provides a highest correlation with the classification associated with the query;
determining, using a contextual bandit, a large language model provider, among the subset of large language model providers, based on a trained model for the contextual bandit;
providing the query to the large language model provider;
receiving a response from the large language model provider; and
updating the trained model for the contextual bandit based on the response.

19. The system of claim 18, wherein the task classifier is a first machine learning model and the contextual bandit is a second machine learning model.

20. The system of claim 18, wherein the updating the trained model for the contextual bandit includes generating a reward score based on the response from the large language model provider, and updating the trained model for the contextual bandit based on the reward score.
